(19) United States
(12) Patent Application Publication
(10) Pub. No.: US 2026/0318742 A1
(43) Pub. Date: Oct. 15, 2026

(54) ELECTRONIC DEVICE FOR RECONSTRUCTING HYPERSPECTRAL IMAGES AND OPERATING METHOD THEREOF

(71) Applicant: ELECTRONICS AND TELECOMMUNICATIONS RESEARCH INSTITUTE, Daejeon (KR)

(72) Inventors: Hanvit KIM, Daejeon (KR); Soohyun LEE, Daejeon (KR); Jeong Won PARK, Daejeon (KR); Seunghwan KIM, Daejeon (KR); Soo Jun PARK, Daejeon (KR); Chul HUH, Daejeon (KR)

(21) Appl. No.: 19/279,386

(22) Filed: Jul. 24, 2025

(30) Foreign Application Priority Data
Apr. 11, 2025 (KR) 10-2025-0047448

(51) Int. Cl. G01J 3/28

(52) U.S. Cl. CPC G01J 3/2823

(57) ABSTRACT

An electronic device for reconstructing hyperspectral images and an operating method thereof are provided. The operating method of the electronic device includes generating a lighting pattern by encoding each of a plurality of light sources included in a multi-channel light source based on a predefined orthogonal spreading code and a light source intensity distribution, obtaining, through a sensor, an optical signal formed by the generated lighting pattern being reflected or transmitted by a target object, and reconstructing a hyperspectral image by decoding the obtained optical signal through the orthogonal spreading code used in an encoding process of the lighting pattern, by using a deep learning-based hyperspectral image reconstruction model.

### CROSS-REFERENCE TO RELATED APPLICATION

This application claims the benefit of Korean Patent Application No. 10-2025-0047448, filed on Apr. 11, 2025, in the Korean Intellectual Property Office, the entire disclosure of which is incorporated herein by reference for all purposes.

### BACKGROUND

### 1. Field of the Invention

One or more embodiments relate to an electronic device for reconstructing hyperspectral images and an operating method thereof.

### 2. Description of the Related Art

Hyperspectral imaging (HSI) is technology that collects information from various wavelength bands (e.g., tens to hundreds of wavelengths) and analyzes chemical and physical characteristics of an object. In addition, HIS is used in various fields such as medicine, agriculture, industrial inspection, environmental monitoring, and the like.

Unlike a general optical camera (e.g., a red, green, and blue (RGB) camera), HSI has a great advantage of being able to obtain optical characteristics that vary according to a wavelength of a subject and, accordingly, being able to analyze not only shapes but also optical characteristics of a material. In particular, HSI has an advantage of being able to quickly and intuitively visualize optical characteristics by detecting a spectrum specific to each wavelength band even for materials of a similar color that are difficult to distinguish with the naked eye. However, HSI also has several technical limitations.

First, since HSI requires a process of collecting data (e.g., spectral scan and spatial scan) in an individual wavelength band, obtaining data requires a long time, and it is difficult to generate an image in real time. Especially in a dynamic environment, time delays occur between frames, which limits the implementation of a real-time hyperspectral image.

In addition, a hyperspectral image contains information of tens to hundreds of wavelength bands in each pixel and may thus require greater data capacity than a general RGB image. Due to the characteristics such as large-capacity data, high-performance equipment is required during storage and transmission of data, and real-time data processing is limited.

Finally, complex computations for high-dimensional data processing are essential to analyze and reconstruct a hyperspectral image. In particular, when decoding and reconstructing an image over a wide area, high-performance computational resources are required due to complex calculations, which leads to the issue of decrease in processing speed as a computational burden increases.

The above information may be presented as the related art to help with the understanding of the present disclosure. No claim or determination is made as to whether any of the above description may be applied as the prior art regarding the present disclosure.

### SUMMARY

Embodiments provide an electronic device that is capable of separating and reconstructing a signal of a multi-channel light source more effectively by applying a light source encoding technique based on code-division multiple access (CDMA) and orthogonal frequency-division multiple access (OFDMA).

In addition, embodiments also provide an electronic device and an operating method thereof, wherein the electronic device is configured to decode a hyperspectral image of a high resolution from an optical signal collected through a sensor, by using a deep learning-based hyperspectral image reconstruction model, and effectively remove noise that may occur in the decoding process to improve reconstruction quality of the hyperspectral image.

However, the technical aspects are not limited to the aforementioned aspects, and other technical aspects may be present.

According to an aspect, there is provided an electronic device including at least one processor and a memory including one or more storage media configured to store instructions, wherein the instructions, when executed individually or collectively by the at least one processor, cause the electronic device to generate a lighting pattern by encoding each of a plurality of light sources included in a multi-channel light source based on a predefined orthogonal spreading code and a light source intensity distribution, obtain, through a sensor, an optical signal formed by the generated lighting pattern being reflected or transmitted by a target object, and reconstruct a hyperspectral image by decoding the obtained optical signal through the orthogonal spreading code used in an encoding process of the lighting pattern, by using a deep learning-based hyperspectral image reconstruction model.

The instructions may, when executed individually or collectively by the at least one processor, cause the electronic device to generate the lighting pattern by encoding each of the plurality of light sources in time sequence in a code division multiple access (CDMA) method, by using an orthogonal spreading code corresponding to each of the plurality of light sources.

The deep learning-based hyperspectral image reconstruction model may include at least one of a mean squared error (MSE) loss function to minimize a difference between the reconstructed hyperspectral image and an actual hyperspectral image, a sparsity loss function that induces sparsity of the reconstructed hyperspectral image to be maintained, or a code consistency loss function for ensuring consistency between the optical signal obtained through the sensor and a result of transforming the reconstructed hyperspectral image into the optical signal through a physics-based forward model comprising a determined transformation matrix.

The code consistency loss function may be calculated using the physics-based forward model, in which a unique response characteristic matrix of the target object for each wavelength is integrated, to reflect wavelength-specific response characteristics of the target object.

The code consistency loss function may be calculated using the physics-based forward model, which is normalized based on a dark field representing a bias component of an optical system.

According to another aspect, there is provided an operating method of an electronic device including generating a lighting pattern by encoding each of a plurality of light sources included in a multi-channel light source, by utilizing a predefined orthogonal spreading code and a light source intensity distribution, obtaining, through a sensor, an optical signal formed by the generated lighting pattern being reflected or transmitted by a target object, and reconstructing a hyperspectral image by decoding the obtained optical signal through the orthogonal spreading code used in an encoding process of the lighting pattern, by using a deep learning-based hyperspectral image reconstruction model.

The generating of the lighting pattern may include generating the lighting pattern by encoding each of the plurality of light sources in time sequence in a code division multiple access (CDMA) method, by using an orthogonal spreading code corresponding to each of the plurality of light sources.

The deep learning-based hyperspectral image reconstruction model may include at least one of a mean squared error (MSE) loss function to minimize a difference between the reconstructed hyperspectral image and an actual hyperspectral image, a sparsity loss function that induces sparsity of the reconstructed hyperspectral image to be maintained, or a code consistency loss function for ensuring consistency between the optical signal obtained through the sensor and a result of transforming the reconstructed hyperspectral image into the optical signal through a physics-based forward model comprising a determined transformation matrix.

The code consistency loss function may be calculated using the physics-based forward model, in which a unique response characteristic matrix of the target object for each wavelength is integrated, to reflect wavelength-specific response characteristics of the target object.

The code consistency loss function may be calculated using the physics-based forward model, which is normalized based on a dark field representing a bias component of an optical system.

According to another aspect, there is provided an operating method of an electronic device including generating a lighting pattern by encoding each of a plurality of light sources included in a multi-channel light source by placing the plurality of light sources at a predefined orthogonal frequency band, obtaining, through a sensor, an optical signal formed by the generated lighting pattern being reflected or transmitted by a target object, and reconstructing a hyperspectral image by decoding the obtained optical signal through frequency-based encoding information of the lighting pattern, by using a deep learning-based hyperspectral image reconstruction model.

Additional aspects of embodiments will be set forth in part in the description which follows and, in part, will be apparent from the description, or may be learned by practice of the disclosure.

According to embodiments, a plurality of optical signals generated from a multi-channel light source may be effectively separated and reconstructed by applying a light source encoding technique based on CDMA and OFDMA to maximize reconstruction efficiency of a hyperspectral image.

In addition, according to embodiments, reconstruction quality of a hyperspectral image may be improved by decoding, using a deep learning-based hyperspectral image reconstruction model, an optical signal collected through a sensor and effectively removing noise that may occur in the decoding process.

### BRIEF DESCRIPTION OF THE DRAWINGS

In the description of the drawings, the same or similar reference numerals may be used to refer to the same or similar components.

These and/or other aspects, features, and advantages of the invention will become apparent and more readily appreciated from the following description of embodiments, taken in conjunction with the accompanying drawings of which:

FIG. 1 is a diagram illustrating an electronic device that reconstructs a hyperspectral image, according to an embodiment;

FIG. 2 is a conceptual diagram illustrating an electronic device that reconstructs a hyperspectral image, according to an embodiment;

FIG. 3 is a diagram illustrating a deep learning-based hyperspectral image reconstruction framework, according to an embodiment; and

FIG. 4 is a diagram illustrating an example of reconstructing a hyperspectral image by an electronic device, according to an embodiment.

### DETAILED DESCRIPTION

The following detailed structural or functional description is provided as an example only and various alterations and modifications may be made to embodiments. Thus, an actual form of implementation is not construed as limited to the embodiments described herein and should be understood to include all changes, equivalents, and replacements within the idea and the technical scope of the disclosure.

As used herein, each of phrases such as “A or B,” “at least one of A and B,” “at least one of A or B,” “A, B, or C,” “at least one of A, B, and C,” and “at least one of A, B, or C” may include any one of the items listed in the corresponding one of the phrases or all possible combinations thereof. Although terms, such as first, second, and the like are used to describe various components, the components are not limited to the terms. These terms should be used only to distinguish one component from another component. For example, a first component may be referred to as a second component, and similarly, the second component may be referred to as the first component.

It should be noted that when one component is described as being “connected,” “coupled,” or “joined” to another component, the first component may be directly connected, coupled, or joined to the second component, or a third component may be connected, coupled, or joined between the first and second components.

The singular forms “a,” “an,” and “the” are intended to include the plural forms as well, unless the context clearly indicates otherwise. It will be further understood that the terms “comprises/comprising” and/or “includes/including,” when used herein, specify the presence of stated features, integers, steps, operations, elements, and/or components, but do not preclude the presence or addition of one or more other features, integers, steps, operations, elements, components and/or groups thereof.

Unless otherwise defined, all terms used herein including technical and scientific terms have the same meanings as those commonly understood by one of ordinary skill in the art to which this disclosure pertains. Terms such as those defined in commonly used dictionaries are to be interpreted as having a meaning that is consistent with their meaning in the context of the relevant art and are not to be interpreted in an idealized or overly formal sense unless expressly so defined herein.

Hereinafter, the embodiments are described in detail with reference to the accompanying drawings. When describing the embodiments with reference to the accompanying drawings, like reference numerals refer to like components and a repeated description related thereto is omitted.

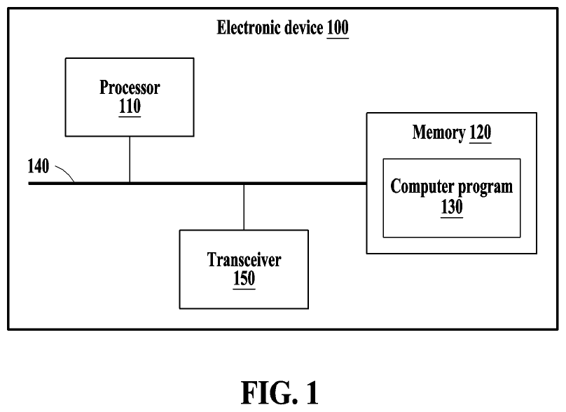

FIG. 1 is a diagram illustrating an electronic device that reconstructs a hyperspectral image, according to an embodiment.

Referring to FIG. 1, an electronic device 100 may include one or more processors 110 and a memory 120 loading or storing a computer program 130 executed by the processor 110. The processor 110 and the memory 120 may be connected to each other via a communication link (e.g., a bus) 140. Optionally, the electronic device 100 may further include a transceiver 150, and the transceiver 150 may be used for data exchange, such as transmission and/or reception of data between the electronic device 100 and other electronic devices. The components included in the electronic device 100 as illustrated in FIG. 1 are only examples, and it is obvious to one of ordinary skill in the art that other general-purpose components may be included in addition to the components illustrated in FIG. 1.

The processor 110 may control the overall operation of each component of the electronic device 100. The processor 110 may be implemented as circuitry (e.g., processing circuitry such as a system on a chip (SoC) or an integrated circuit (IC). The processor 110 may include one or more processors. For example, the processor 110 may include a combination of one or more processors, such as a central processing unit (CPU), a microprocessor unit (MPU), a microcontroller unit (MCU), a graphics processing unit (GPU), a neural processing unit (NPU), a digital signal processor (DSP), an application processor (AP), a communication processor (CP), or other types of processors that are well known in the art of the present disclosure. In addition, the processor 110 may perform operations on the computer program 130 or at least one application to execute a method and/or an operation according to various embodiments of the present disclosure.

The memory 120 may store one or a combination of two or more of various pieces of data, instructions, and pieces of information that are used by a component (e.g., the processor 110) included in the electronic device 100. The memory 120 may include volatile memory and/or non-volatile memory.

The computer program 130 may include one or more actions implementing the methods and/or operations according to various embodiments of the present disclosure and may be stored in the memory 120 as software. Here, an operation may correspond to an instruction that is implemented in the computer program 130. For example, the computer program 130 may include instructions that cause the electronic device 100 to perform operations of generating a lighting pattern by encoding each of a plurality of light sources included in a multi-channel light source based on a predefined orthogonal spreading code and a light source intensity distribution, obtaining, through a sensor, an optical signal formed by the generated lighting pattern being reflected or transmitted by a target object, and reconstructing a hyperspectral image by decoding the obtained optical signal through the predefined orthogonal spreading code used in an encoding process of the lighting pattern, by using a deep learning-based hyperspectral image reconstruction model.

When the computer program 130 is loaded in the memory 120, the processor 110 may execute a plurality of operations to implement the program 130 and accordingly may perform the methods and/or operations according to various embodiments of the present disclosure.

The communication link 140 may include a path for transmitting at least one of various pieces of data, instructions, and pieces of information between components included in the electronic device 100. The communication link 140 may be, for example, a peripheral component interconnect (PCI) bus or an extended industry standard architecture (EISA) bus, but these types of buses are only examples, and embodiments are not limited thereto. For example, referring to FIG. 1, a bus is represented by a single line for ease of description, but in reality, a plurality of buses or various types of buses may be included.

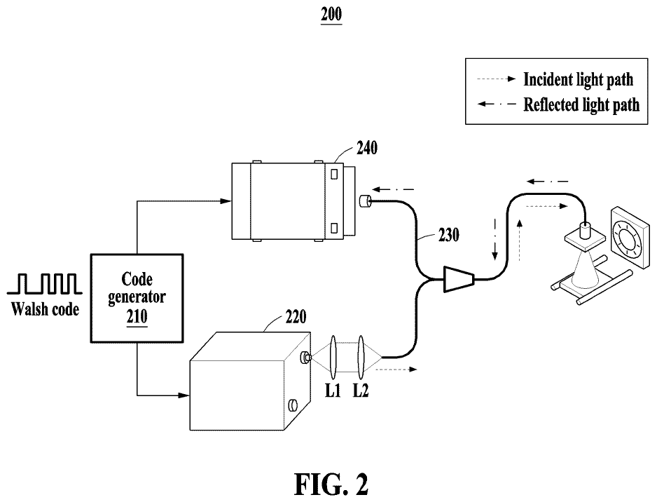

FIG. 2 is a conceptual diagram illustrating an electronic device that reconstructs a hyperspectral image, according to an embodiment.

Referring to FIG. 2, the electronic device (e.g., the electronic device 100 of FIG. 1) may include at least one of a code generator 210, a multi-channel light source 220, an optical fiber system 230, or a sensor 240. A processor (e.g., the processor 110 of FIG. 1) of the electronic device may perform an entire process for deep learning-based hyperspectral image reconstruction by controlling each of components included in the electronic device.

Firstly, the code generator 210 may generate an orthogonal spreading code corresponding to each of a plurality of light sources included in the multi-channel light source 220. The generated orthogonal spreading code may be designed to efficiently transmit multiple signals by minimizing mutual interference. For example, the code generator 210 may generate the orthogonal spreading code corresponding to each of the plurality of light sources by using at least one of Walsh code, gold code, Hadamard code, or pseudo-noise (PN) code, which are widely used in the code division multiple access (CDMA) method. However, these types of orthogonal spreading code are only examples, and embodiments are not limited thereto.

The multi-channel light source 220 may generate a lighting pattern by encoding each of the plurality of light sources included in the multi-channel light source 220 in time sequence in the CDMA method, by using the orthogonal spreading code generated by the code generator 210. Here, the multi-channel light source 220 may project a lighting pattern that is generated by individually or simultaneously encoding the plurality of light sources toward a target object, and the lighting pattern projected toward the target object may be implemented in a form of synthesized light that includes spectral information of each wavelength band.

The optical fiber system 230 may provide an optical path for projecting the lighting pattern generated by the multi-channel light source 220 to the target object, and the sensor (e.g., a high-speed camera) 240 may receive light and obtain an optical signal, which is a lighting pattern reflected or transmitted by the target object through the optical fiber system 230. The sensor 240 may convert the obtained optical signal into a digital signal and provide the digital signal to a next step.

The processor may reconstruct the hyperspectral image by decoding, using the deep learning-based hyperspectral image reconstruction model, the optical signal converted into the digital signal through the sensor 240 and removing noise. Here, the deep learning-based hyperspectral image reconstruction model may reconstruct the hyperspectral image of high resolution by decoding the optical signal, which has been converted into the digital signal, using the orthogonal spreading code used in an encoding process of the lighting pattern.

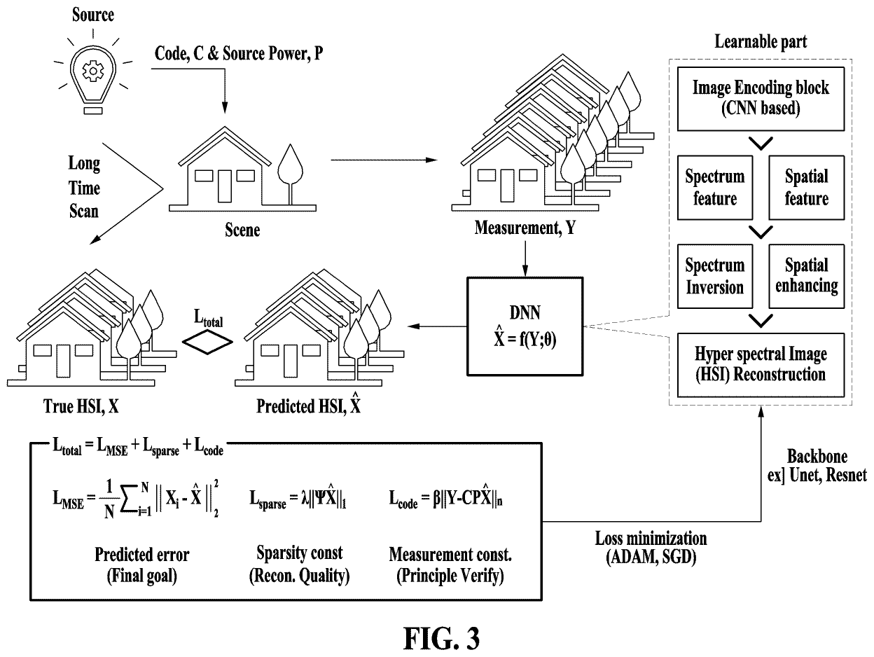

FIG. 3 is a diagram illustrating a deep learning-based hyperspectral image reconstruction framework (hereinafter, the framework), according to an embodiment. According to an embodiment, the framework shown in FIG. 3 may be implemented or performed by at least one component included in an electronic device (e.g., the electronic device of FIG. 1).

Referring to FIG. 3, the electronic device may efficiently reconstruct a hyperspectral image by using a CDMA-based light source irradiation scheme. Firstly, the electronic device may predefine an orthogonal spreading code C for each of a plurality of light sources included in a multi-channel light source (e.g., the multi-channel light source 220 of FIG. 1) through a code generator (e.g., the code generator 210 of FIG. 1).

The electronic device may generate a lighting pattern by encoding each of the plurality of light sources included in the multi-channel light source in time sequence, in the CDMA method, by utilizing the orthogonal spreading code C predefined as described above and a light source intensity distribution P. The CDMA method is a method of distinguishing and encoding each light source on a time axis by using the orthogonal spreading code C, which may collect, through a sensor (e.g., the sensor 240 of FIG. 2), synthesized light irradiated to a target object (e.g., a scene) for a reference time and decode the synthesized light through the orthogonal spreading code C to separate each wavelength component. The CDMA method has an advantage of being easily implemented in environments with less light sources and facilitating real-time processing of the above-described operations.

The electronic device may irradiate the generated lighting pattern to the target object, which is a target of observation, and may collect, through the sensor such as a high-speed camera, an optical signal Y reflected or transmitted by the target object. The collected optical signal Y may be a synthesized signal in which a plurality of wavelength components is synthesized, which may include data in which light irradiated from each light source are superposed according to the orthogonal spreading code C.

Here, a relationship between a hyperspectral image cube X, which represents the lighting pattern irradiated to the target object, and the optical signal Y received through the sensor after being reflected by the target object may be modeled as in Equation 1 below.

Y=CPX+N [Equation 1]

Here, Y denotes the optical signal (e.g., time T×space M) collected through the sensor, and C denotes an orthogonal spreading code in a form of a matrix (e.g., the number of light sources L×time T) predefined for the plurality of light sources. P denotes a light source intensity distribution matrix that represents the intensity of each light source, X denotes the hyperspectral image cube, and N denotes a noise element.

That is, the optical signal Y collected through the sensor may be expressed in a form of a combination of the orthogonal spreading code C for encoding the multi-channel light source, the light source intensity distribution matrix P, and the hyperspectral image cube X with the noise element N added.

Assuming an ideal condition in which the orthogonal spreading code C for encoding the multi-channel light source in the CDMA method is well known and the noise element N does not exist, the hyperspectral image cube X may be reconstructed through a basic linear inverse operation as in Equation 2 below.

\hat{X}=P⁻¹C^{T}Y [Equation 2]

Here, \hat{X} denotes a reconstructed hyperspectral image cube, and P⁻¹C^{T} denotes an inverse transformation matrix reflecting the orthogonal spreading code C and the light source intensity distribution matrix P.

In a real system, however, the noise element N may exist, and the linear inverse operation method alone may have limitations in accurately reconstructing the hyperspectral image cube X as the number of light sources increases.

Thus, for noise removing and more accurate signal reconstruction, the electronic device of the present disclosure may provide a method of reconstructing the hyperspectral image cube \hat{X} by utilizing a deep learning-based hyperspectral image reconstruction model, as in Equation 3 below.

\hat{X}=ƒ(Y;θ) [Equation 3]

Here, ƒ(Y; θ) denotes the deep learning-based hyperspectral image reconstruction model that receives, as an input, the optical signal Y collected through the sensor and predicts the hyperspectral image cube X, and θ denotes a learnable parameter set of the deep learning-based hyperspectral image reconstruction model.

The deep learning-based hyperspectral image reconstruction model according to the present disclosure may be trained to minimize a difference between the predicted hyperspectral image cube \hat{X} and the actual hyperspectral image cube X. In this case, the actual hyperspectral image cube X may include hyperspectral image data having a high signal-to-noise ratio (SNR), which may be obtained through scanning for each wavelength for a long period of time.

In addition, the deep learning-based hyperspectral image reconstruction model according to the present disclosure may include a function to extract a spectral feature for separating an individual wavelength component from a lighting pattern in a form of synthesized light to resolve an inverse problem as well as a function to extract a spatial feature for improving image quality by utilizing a spatial structure commonly shown in the same scene.

These functions may be performed through a convolutional neural network (CNN)-based encoding structure, and network architectures such as U-Net, ResNet, and the like may be used. The deep learning-based hyperspectral image reconstruction model may be trained to minimize a total loss function Lₜₒₜₐₗ, in which a plurality of loss functions is combined, as in Equation 4 below.

Lₜₒₜₐₗ=L_{MSE}+Lₛₚₐᵣₛₑ+L_{code} [Equation 4]

Here, the first loss function L_{MSE} denotes an MSE loss function and may minimize an error between the hyperspectral image cube \hat{X} predicted through the deep learning-based hyperspectral image reconstruction model and the actual hyperspectral image cube X. The loss function L_{MSE} may be defined as Equation 5 below.

$${L}_{MSE} = \frac{1}{N} {\sum }_{i = 1}^{N} {‖ {X}_{i} - \hat{X} ‖}_{2}^{2} \qquad [ Equation 5 ]$$

The second loss function Lₛₚₐᵣₛₑ denotes a sparsity loss function and may enhance sparsity for the predicted hyperspectral image cube X in a particular transformation domain (e.g., Ψ, Identity, Wavelet, and discrete cosine transform (DCT)) to improve the image quality. The loss function Lₛₚₐᵣₛₑ may be defined as Equation 6 below.

Lₛₚₐᵣₛₑ=λ∥Ψ\hat{X}∥₁ [Equation 6]

Here, Ψ denotes sparsity transformation, and ∥·∥₁ denotes an L1 norm.

Finally, the loss function L_{code} denotes a code consistency loss function and may minimize an error between the optical signal Y, which is actually obtained through the sensor, and an optical signal Ŷ=CP\hat{X}, wherein the predicted hyperspectral image cube \hat{X} is transformed through the physics-based forward model back to a measurement value, that is, the optical signal Ŷ=CP\hat{X}. The loss function L_{code} may be defined as Equation 7 below.

L_{code}=β∥Y−C\hat{X}∥ₙ [Equation 7]

The loss function L_{code} may force the deep learning-based hyperspectral image reconstruction model to carry out a physical irradiation principle and may function as a core constraint in the entire framework. Here, ∥·∥ₙ may denote the L1 norm or an L2 norm.

That is, the deep learning-based hyperspectral image reconstruction framework according to the present disclosure may realize hyperspectral image reconstruction with high accuracy by integrating a physics-based model and a data-based model. Accordingly, the deep learning-based hyperspectral image reconstruction framework according to the present disclosure may allow to quickly and efficiently obtain a hyperspectral image even in an application environment in which long-term scanning is difficult and may thus be utilized in various fields.

In addition, the deep learning-based hyperspectral image reconstruction model may be trained to minimize the loss function (e.g., the MSE loss function, the sparsity loss function, and the code consistency loss function) defined above. In this case, an adaptive moment estimation (ADAM) method, a stochastic gradient descent (SGD) method, or other well-known optimization techniques may be used in an optimization process for minimizing an error. These optimization algorithms may gradually search for an optimized value in a parameter space for a differentiable loss function and may be selected appropriately according to convergence speed and generalization performance.

The deep learning-based hyperspectral image reconstruction model may be configured to include a plurality of neural network layers, wherein each of the neural network layers may include a learnable parameter set θ. The deep learning-based hyperspectral image reconstruction model may be trained by iteratively updating the parameter set θ so that a value of the predefined loss function may be minimized.

For example, the present disclosure may gradually adjust the parameter set θ by using an optimization algorithm such as ADAM, SGD, and the like and may implement a high-precision deep learning-based hyperspectral image reconstruction model that reflects both a physical principle and a data-based pattern to input data.

According to an embodiment, the deep learning-based hyperspectral image reconstruction model according to the present disclosure may enhance reconstruction quality of a hyperspectral image by introducing an additional loss item.

For example, an optical signal measured through a sensor may be affected by a characteristic (e.g., a sensitivity characteristic) of a particular camera and optical sensor. Thus, the electronic device according to the present disclosure may design an additional loss item for responsivity calibration for each piece of equipment.

More specifically, the electronic device may integrate a unique response characteristic matrix R, which indicates wavelength-specific response characteristics (e.g., responsivity or transmittance) of a target object to be measured, with the physics-based forward model, thereby modeling a more accurate optical transfer process.

Here, when the existing physics-based forward model is defined as Y=CPX+N, the forward model may be expanded into Y=CPRX+N by integrating the unique response characteristic matrix R.

In addition, the electronic device according to the present disclosure may perform dark field correction to additionally correct a low-light area or an area having a lot of noise within a hyperspectral image, thereby realizing reconstruction of a hyperspectral image robust to noise and a system bias component.

More specifically, a bias component (e.g., stray light and thermal noise) specific to an optical system may be estimated through a separate measurement using only a light source and a sensor, without a target object. Here, an estimated signal may be a dark field value. In a reconstruction process, the bias component of the optical system may be corrected in a normalization method by using the dark field value. Accordingly, the entire physics-based forward model may be expressed in a normalized form, such as

$$Y = \frac{CPRX}{D} + N .$$

When applying this to the loss function, the existing code consistency loss function may be modified as Equation 8 below.

L_{code}=β∥Y−CPR\hat{X}/D∥ₙ [Equation 8]

This configuration may effectively remove sensitivity difference and light deflection of the optical system and accordingly realize more reliable reconstruction of a hyperspectral image.

As described above, the method of reconstructing a hyperspectral image according to the present disclosure may efficiently reconstruct the hyperspectral image even in a large-scale image pixel area and may be utilized in various application fields in real time, such as in medical diagnosis or industrial material inspection. Furthermore, when selectively utilized for a determined detection band, the method may perform highly sensitive detection and precise analysis on a determined material or state.

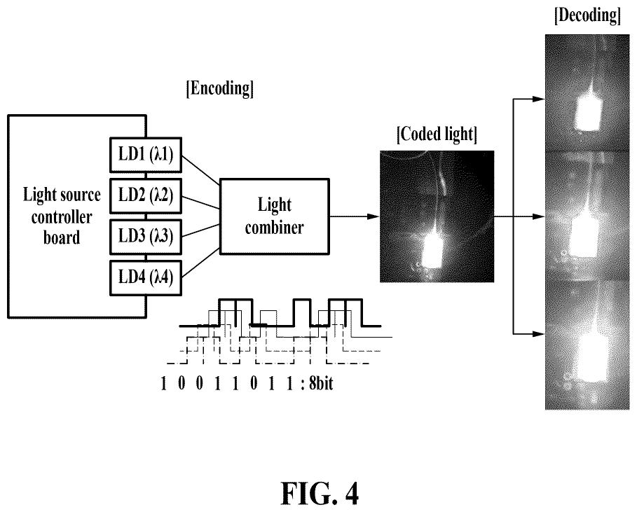

FIG. 4 is a diagram illustrating an example of reconstructing a hyperspectral image by an electronic device, according to an embodiment.

According to an embodiment, a processor (e.g., the processor 110 of FIG. 1) of the electronic device (e.g., the electronic device 100 of FIG. 1) may reconstruct a hyperspectral image for each wavelength through a method of reconstructing a hyperspectral image, the method provided by the present disclosure, as illustrated in FIG. 4.

Referring to FIG. 4, a light source controller board may generate light sources having different center wavelengths (e.g., λ₁, λ₂, λ₃, and λ₄) through a plurality of laser diodes LD1 to LD4, and each of the light sources may be modulated and encoded on a time axis based on a predefined orthogonal spreading code (e.g., an 8-bit sequence).

The encoded light sources may be combined into a single light path through a light combiner to form coded irradiation light, which may be irradiated onto an observation target (e.g., a scene).

The coded irradiation light irradiated onto the observation target may include a plurality of pieces of wavelength information as described above, but the plurality of pieces of wavelength information is encoded based on the orthogonal spreading code. A deep learning-based hyperspectral image reconstruction model may separate (or decode), from a measured signal, optical information corresponding to an individual wavelength.

Referring to FIG. 4, an example of a result of decoding is illustrated, in which each single wavelength component (e.g., R, G, and B) is output in a form of an image.

In addition to the CDMA method, the electronic device according to the present disclosure may perform encoding in the orthogonal frequency division multiple access (OFDMA) method to generate a lighting pattern, by placing each of a plurality of light sources included in a multi-channel light source at an orthogonal frequency band having a predefined frequency interval. The OFDMA method divides and irradiates light sources by utilizing multiple bands orthogonal on a frequency axis and has an advantage of being able to obtain and decode irradiated light for a shorter or longer time since the OFDMA method does not require a reference time. In particular, as the number of light sources increases, the sparsity of the frequency domain may be better utilized, in which case the OFDMA method has an advantage of performing clearer wavelength separation and decoding.

The components described in the embodiments may be implemented by hardware components including, for example, at least one DSP, a processor, a controller, an application-specific integrated circuit (ASIC), a programmable logic element, such as a field programmable gate array (FPGA), other electronic devices, or combinations thereof. At least some of the functions or the processes described in the embodiments may be implemented by software, and the software may be recorded on a recording medium. The components, the functions, and the processes described in the embodiments may be implemented by a combination of hardware and software.

The embodiments described herein may be implemented using a hardware component, a software component, and/or a combination thereof. For example, a processing device may be implemented using one or more general-purpose or special-purpose computers, such as, for example, a processor, a controller, an arithmetic logic unit (ALU), a DSP, a microcomputer, an FPGA, a programmable logic unit (PLU), a microprocessor, or any other device capable of responding to and executing instructions in a defined manner. The processing device may run an operating system (OS) and one or more software applications that run on the OS. The processing device may also access, store, manipulate, process, and create data in response to execution of the software. For purpose of simplicity, the processing device is described as singular. However, one of ordinary skill in the art will appreciate that a processing device may include multiple processing elements and/or multiple types of processing elements. For example, the processing device may include a plurality of processors, or a single processor and a single controller. In addition, different processing configurations are possible, such as one including parallel processors.

The software may include a computer program, a piece of code, instructions, or one or more combinations thereof, to independently or collectively instruct or configure the processing device to operate as desired. The software and/or data may be stored in any type of machine, component, physical or virtual equipment, or computer storage medium or device for the purpose of being interpreted by the processing device or providing instructions or data to the processing device. The software may also be distributed over network-coupled computer systems so that the software is stored and executed in a distributed fashion. The software and data may be stored in a non-transitory computer-readable recording medium.

The methods according to the embodiments may be recorded in non-transitory computer-readable media including program instructions to implement various operations of the embodiments. The media may also include the program instructions, data files, data structures, and the like alone or in combination. The program instructions recorded on the media may be those specially designed and constructed for the embodiments, or they may be of the kind well-known and available to those having skill in the computer software arts. Examples of non-transitory computer-readable media include magnetic media such as hard disks, floppy disks, and magnetic tape; optical media such as compact disc read-only memory (CD-ROM) discs and digital video discs (DVDs); magneto-optical media such as optical disks; and hardware devices that are specially configured to store and perform program instructions, such as read-only memory (ROM), random-access memory (RAM), flash memory, and the like. Examples of program instructions include both machine code, such as those produced by a compiler, and files containing high-level code that may be executed by the computer using an interpreter.

The above-described hardware devices may be configured to act as one or more software modules in order to perform the operations of the above-described embodiments, or vice versa.

Although the embodiments have been described with reference to the limited number of drawings, one of ordinary skill in the art may apply various technical modifications and variations based thereon. For example, suitable results may be achieved if the described techniques are performed in a different order and/or if components in a described system, architecture, device, or circuit are combined in a different manner and/or replaced or substituted by other components or their equivalents.

Therefore, other implementations, other embodiments, and equivalents to the claims are also within the scope of the following claims.

What is claimed is:

1. An electronic device comprising:
at least one processor; and
a memory comprising one or more storage media configured to store instructions,
wherein the instructions, when executed individually or collectively by the at least one processor, cause the electronic device to:
generate a lighting pattern by encoding each of a plurality of light sources included in a multi-channel light source based on a predefined orthogonal spreading code and a light source intensity distribution;
obtain, through a sensor, an optical signal formed by the generated lighting pattern being reflected or transmitted by a target object; and
reconstruct a hyperspectral image by decoding the obtained optical signal through the predefined orthogonal spreading code used in an encoding process of the lighting pattern, by using a deep learning-based hyperspectral image reconstruction model.

2. The electronic device of claim 1, wherein the instructions, when executed individually or collectively by the at least one processor, cause the electronic device to:
generate the lighting pattern by encoding each of the plurality of light sources in time sequence in a code division multiple access (CDMA) method, by using an orthogonal spreading code corresponding to each of the plurality of light sources.

3. The electronic device of claim 1, wherein the deep learning-based hyperspectral image reconstruction model comprises at least one of:
a mean squared error (MSE) loss function to minimize a difference between the reconstructed hyperspectral image and an actual hyperspectral image;
a sparsity loss function that induces sparsity of the reconstructed hyperspectral image to be maintained; or
a code consistency loss function for ensuring consistency between the optical signal obtained through the sensor and a result of transforming the reconstructed hyperspectral image into the optical signal through a physics-based forward model comprising a determined transformation matrix.

4. The electronic device of claim 3, wherein the code consistency loss function is calculated using the physics-based forward model, in which a unique response characteristic matrix of the target object for each wavelength is integrated, to reflect wavelength-specific response characteristics of the target object.

5. The electronic device of claim 3, wherein the code consistency loss function is calculated using the physics-based forward model, which is normalized based on a dark field representing a bias component of an optical system.

6. An operating method of an electronic device, the operating method comprising:
generating a lighting pattern by encoding each of a plurality of light sources included in a multi-channel light source, by utilizing a predefined orthogonal spreading code and a light source intensity distribution;
obtaining, through a sensor, an optical signal formed by the generated lighting pattern being reflected or transmitted by a target object; and
reconstructing a hyperspectral image by decoding the obtained optical signal through the predefined orthogonal spreading code used in an encoding process of the lighting pattern, by using a deep learning-based hyperspectral image reconstruction model.

7. The operating method of claim 6, wherein the generating of the lighting pattern comprises:
generating the lighting pattern by encoding each of the plurality of light sources in time sequence in a code division multiple access (CDMA) method, by using an orthogonal spreading code corresponding to each of the plurality of light sources.

8. The operating method of claim 6, wherein the deep learning-based hyperspectral image reconstruction model comprises at least one of:
a mean squared error (MSE) loss function to minimize a difference between the reconstructed hyperspectral image and an actual hyperspectral image;
a sparsity loss function that induces sparsity of the reconstructed hyperspectral image to be maintained; or
a code consistency loss function for ensuring consistency between the optical signal obtained through the sensor and a result of transforming the reconstructed hyperspectral image into the optical signal through a physics-based forward model comprising a determined transformation matrix.

9. The operating method of claim 8, wherein the code consistency loss function is calculated using the physics-based forward model, in which a unique response characteristic matrix of the target object for each wavelength is integrated, to reflect wavelength-specific response characteristics of the target object.

10. The operating method of claim 8, wherein the code consistency loss function is calculated using the physics-based forward model, which is normalized based on a dark field representing a bias component of an optical system.

11. An operating method of an electronic device, the operating method comprising:
generating a lighting pattern by encoding each of a plurality of light sources included in a multi-channel light source by placing the plurality of light sources at a predefined orthogonal frequency band;
obtaining, through a sensor, an optical signal formed by the generated lighting pattern being reflected or transmitted by a target object; and
reconstructing a hyperspectral image by decoding the obtained optical signal through frequency-based encoding information of the lighting pattern, by using a deep learning-based hyperspectral image reconstruction model.
